(19) United States
(12) Patent Application Publication
(10) Pub. No.: US 2013/0073211 A1
(43) Pub. Date: Mar. 21, 2013

(54) MICROCONTROLLER BASED PEDIATRIC DEVICE AND METHOD OF NOURISHMENT EVALUATION

(71) Applicant: Samuel Hershkovich, Brooklyn, NY (US)

(72) Inventor: Samuel Hershkovich, Brooklyn, NY (US)

(21) Appl. No.: 13/238,478

(22) Filed: Sep. 21, 2011

(51) Int. Cl. G01P 5/08; G06F 19/00

(52) U.S. Cl. 702/19; 702/47

(57) ABSTRACT

A microcontroller based breast milk flow meter and child milk volume intake detection and measuring method means comprising a silicone encapsulated flexible microcontroller circuit means with a plurality of on-board dielectric detector plate means and a piezo-resistive force sensor means. Where the dielectric detector plates function electrically, as a passive device means to determine the presence or absence of a quantity of milk in a holding chamber means and a piezo-resistive force sensor function electrically, as a passive device means to determine a continuous or sporadic flow quantity of milk from said chamber means. A special microcontroller algorithm is used to monitor, detect, and measure breast milk flow and quantity from mother to child.

### FIELD OF THE INVENTION

The present invention relates to the utilization of microcontrollers, especially in the role as an accurate and instant method means of detecting and measuring pediatric fluid flow and fluid volume; either continuous or sporadic. More specifically, the detection and measurement of mother-to-child milk flow and child ingestion quantity in the process of breast feeding.

### BACKGROUND OF THE INVENTION

The field of the present invention is with limit, represented by several prior art patents and the prior art for analyzing infant feeding performance by utilizing quantitative measurements are known. For example U.S. Pat. No. 5,827,191 issued to Rosenfeld discloses A method for monitoring a volume of milk during breast feeding utilizes an elastic nipple shaped cover applied over a nipple area of a woman's breast with holes in the cover positioned above the nipple area for passage of milk to the baby's mouth. A micro measurement volume sensor is located in a space between the nipple and the elastic cover holes to measure the volume of milk flowing therethrough. Data from the micro measurement volume sensor is converted into a calibrated volumetric equivalent corresponding to milk volume data indicative of the milk volume. This milk volume data may be displayed in real time on a display monitor. U.S. patent application Ser. No. 11/846,860 filed by Feldkamp et al. discloses a method for quantifying breastfeeding between a mother and a baby, the method including measuring a physiological volume indicative of stomach fullness volume for the baby; setting a signal threshold value of the physiological volume to correspond to a stomach level that is less than or equal to the stomach fullness volume; obtaining an objective measurement of the physiological volume indicative of a level of fullness of the baby's stomach; and providing an indication to the mother when the objective measurement equals or exceeds the signal threshold value. In one embodiment, for instance, a conductivity sensor may be used to determine the amount of breast milk available in a breast and/or the amount of breast milk that has left the breast during a breastfeeding event. U.S. patent application Ser. No. 12/776/023 filed by Binder discloses a device for measuring characteristics of fluid excreted from an organ of the human body, including electrodes; a power source; and a data processing system including a power regulation module and a measurement module. The electrodes are connected to the power source via the data processing system and are arranged in an array in contact of the human body in vicinity of the fluid excreting organ. The array characterized by a predefined spatial arrangement of the electrodes that is related to the form of the fluid excreting organ. The power regulation module is arranged to supply the electrodes with an electric current characterized by predefined parameters and the measurement module is arranged to measure characteristics of the excreted fluid from evolved potentials on the human body due to the electric current, in relation to the predefined spatial arrangement of the electrodes in the array. U.S. patent application Ser. No. filed by Kapon et al. discloses a method of monitoring amount of milk consumed by an infant being breastfed by a breast is disclosed. The method comprises: determining variations in electric capacitance of the breast during breastfeeding, and correlating the electric capacitance variations to an amount of milk consumed by the infant. U.S. patent application Ser. No. 11/631,378 filed by Shemesh et al. discloses a device and method for measuring the amount of milk supplied to a feeding infant. The device comprises a cap having a nipple-shaped region with an inner surface and an outer surface and a duct extending therebetween. The duct has an inlet at the inner surface and an outlet at the outer surface. The cap is adapted to be mounted on the nipple region of a woman's breast with the inner surface facing the woman's breast and to allow breast-milk to pass through the duct. The device further comprises a sensor associated with the duct for measuring at least milk volume passing through the duct and providing data indicative of the volume. The sensor is embedded between the inner and outer surface of the cap. U.S. Pat. No. 7,896,835 issued to Dahan et al. discloses a system for measuring fluid intake by a sucking baby. The system includes: a feeding pathway for fluid flow from the fluid source to the baby's mouth, wherein the feeding pathway has a first opening in communication with the fluid source and a second opening in communication with the baby's mouth; and an indicator pathway for indicating the amount of fluid provided to the baby's mouth through the feeding pathway, wherein the indicator pathway has a first opening in communication with the fluid source and a second opening in communication with the baby's mouth. The amount of fluid drawn into the indicator pathway is indicative of the amount of fluid drawn into the feeding pathway. U.S. patent application Ser. No. 12/920,178 filed by Zemel et al. discloses Devices, systems and methods for measuring infant feeding performance. The device includes a body portion, a pressure sensor and an integrated circuit. The body portion includes a first end for receiving a fluid, a second end mateable with a feeding nipple, and a conduit In fluid communication with the first and second ends. The pressure sensor is disposed in the body portion, is in contact with the fluid in the conduit, and generates a signal representing a pressure of the fluid passing through the conduit during a feeding session. The integrated circuit is disposed in the body portion and is electrically so connected to the pressure sensor. The integrated circuit receives the pressure signal and determines a feeding factor over the feeding session indicative of the infant feeding performance.

Notwithstanding these efforts, there remains a need for a device that can conveniently and accurately monitor, detect, and monitor an infant's responsiveness and fluid intake during a typical feeding session. Specifically, there remains a need for a device that is; small, stand alone, battery powered, synergistic, has ease of operation factors, is self contained with a built in microcontroller and display, utilizes a priority microcontroller algorithm that establishes a capacity and capability for monitoring, detecting, and controlling in an optimized fashion; the feeding flow rate and volume levels of fluid from mother-to-child feeding sessions.

### SUMMARY OF THE INVENTION

A device and method means consistent with the principles of the present invention for instant pediatric detection and measuring any presence of ejected fluid during a ‘breast-to-infant mouth’ feeding session. Said instant measuring is firstly of; the presence of ejected nourishment fluid from a nipple when said fluid enters a volume transfer chamber that comprises the cannula section of said present invention. This method means also includes instant detection, measurement, and monitoring of fluid no flow being transferred through said cannula of said present invention. All of said instant measurement is of fluid presence, flow rate, and consumed volume of fluid by said infant during a feeding session.

A device method means consistent with the principles of the present invention for instant and accumulated data collection storage of measuring infant feeding performance by a method means of utilizing a microcontroller and prioritized programmed algorithms dedicated to said measuring method means and capable of re-programming and extraction of collected and stored data for transferring and uploading to other external computer means. Said prioritized algorithms can be substituted by alternative programming algorithms, which should be obvious to anyone steeped in the art.

A device method means consistent with the principles of the present invention for infant feeding session performance that includes a breast cup embodiment in communication with an opposed end nipple with small hole for fluid flow, and a first section of a flexible etched printed circuit embodiment containing a microcontroller and a plurality of associated electrical components disposed with a hollow cannula embodiment; and said flexible etched printed circuit means is further comprised of two embedded electrically and mechanically separated conductive plate sections that are identified as, and comprises a passive electrical capacitor. Said conductive plate section means disposed internally on said flexible etched circuit embodiment and silicone no encapsulated within said breast cup embodiment and folded in a circular tubular formation within. Said conductive plates are folded and said formation comprises an electrical capacitor member means, whose capacitance value is affected and changed by the presence or absence of a nipple and the presence or absence of fluid in said cannula means as compared to air in said chamber without nipple and fluid. Said passive electrical capacitor is utilized as a resonant frequency deviation technique for causing a change is the resonant frequency of a hysteretic astable RC oscillator, by the C coefficient in the resonant frequency design equation of said oscillator.

A method means consistent with the principles of the present invention includes; a direct and complete unimpeded fluidic circuitous feeding path between said nipple fluidic source and said infant's lips and mouth opening during a breast feeding session. Said fluidic source is in communication with a first opening, breast cover substrate, and said fluid ejected is in communication with a second surrogate silicone nipple small opening means, which is in communication with said infant's lips and mouth opening.

A method means consistent with the principles of the present invention includes; an air filled soft buffer that fits onto the breast cover to act as a buffer region that aids in the comfort and relaxation of a pediatric recipient during a nourishment feeding session.

A method means consistent with the principles of the present invention includes; a FlexiForce® piezo-resistive thin film embodiment or similar flexible piezo-resistive thin film embodiment is encapsulated within silicone whereby its functional displacement is a method means of determining a volume of fluid that is captured and consumed by an infant during a typical feeding session. Said piezo-resistive embodiment is in the form of a silicone encapsulated toroid disposed perpendicular to and whose inner torus hole surrounds said surrogate nipple means and is in communication with said complete unimpeded fluidic circuitous feeding path between said nipple fluidic source and said infant's lips and mouth opening. Said passive piezo-resistive thin film member means is utilized as a resonant frequency deviation technique for causing a change is the resonant frequency of a hysteretic astable RC oscillator, by the R coefficient in the resonant frequency design equation of said oscillator.

A device method means consistent with the principles of the present invention includes; an effective sectional volume, defined as that internal volume chamber portion member means between said perpendicular disposed toroid piezo-resistive encapsulated embodiment and said second opening defined as said surrogate nipple small opening; and in communication with said infant's lips and mouth opening. Said effective sectional volume, when filled with fluid generated from an infant's sucking, is the effective sample utilized in determining infant intake volume. This volume sample of fluid is established firstly by said infant's lips closing and pinching off, filling, and capturing an amount of fluid in said sectional ‘chamber pathway’ volume; and secondly during said infant's reaction of sucking disposes said fluid volume into it's mouth.

A device and method means consistent with the principles of the present invention includes; generating a resonant change and deviation of a volume quantification type RC oscillator circuit utilizing a change electrical resistance, caused by the deformation of said piezo-resistive toroid for any functional purpose of said present invention.

A device and method means consistent with the principles of the present invention includes; generating a dielectric change in a section of said cannula that is identified as a volume utilized as a dielectric constant that is disposed as a functional member means of a cylindrical electrical capacitor member means, embedded within a flexible etched printed circuit and said cylindrical electrical capacitor is utilized as a method means for causing a resonant change in fluid volume presence RC type oscillator, which is utilized to determine the presence of a breast fluid source supply nipple and the presence of said nourishment fluid.

A device and method means consistent with the principles of the present invention includes; a microcontroller and associated functional components in communication with each other that utilizes computer algorithms to interpret and translate electrical changes in a plurality of RC type oscillator member means dedicated to altering the signal frequencies of said plurality of RC oscillators that are stored in a system memory and further are converted into a usable display member means that is an instant visual indication of nipple nourishment fluid flow values and nourishment volume consumption by a pediatric recipient during a pediatric feeding session; to give an accurate and usable account history of a plurality of feeding sessions necessary for the continued health and nourishment of a pediatric recipient.

The present invention teaches what the prior art fails to do, wherein there is an elementary and optimized methodology for accurately measuring flow rate and volume of a fluid through a fixed conduit by mean of fundamental electrical properties of passive elements of resistance and capacitance that directly has an affect upon a plurality of active electronic device means in the form of a regenerative amplifier or oscillator; and that through computer algorithms stored in firmware, said fluid flow rates and volumes can be determined, collected, stored and exchanged with other computer device means.

The present invention further teaches that fluid flow and volume consumption of an infant during a breast feeding session can be accurately modeled and determined by computer algorithms stored in firmware that accumulate such data and utilize Monte Carlo and other similar mathematical methods instead of deterministic algorithms less accurate due to a plurality of co-factors.

The foregoing background and summary are not intended to be comprehensive, but rather to serve as an aid to artisans of ordinary skill to understand the following implementations consistent with the present invention set forth in the appended claims. In addition, the foregoing background and summary are not intended to provide any independent limitations on the claimed invention.

### BRIEF DESCRIPTION OF THE DRAWINGS

FIG. 1, illustrates the overall present invention with several perspective views.

FIG. 2, is an illustration of front and back views of the present invention, showing a plurality of data entry and collection ports.

FIG. 3, illustrates the flexible etched printed circuit configuration with microcontroller region, cylindrical capacitor region, and the toroid piezo-resistive region.

FIG. 4, is an illustration of a soft air filled buffer device.

FIG. 5, is an illustration of a back view showing the data input and output ports and flexible cable joint and cable.

FIG. 6, is an illustration of a front view showing the small opening in nipple for feed through.

FIG. 7, shows details of the flexible etched printed circuit member means, piezo-resistive component and the cylindrical bands utilized as an electrical capacitor.

FIG. 8, show the connection of the invention placed over a breast and connected to a stand-alone portable battery powered microcontroller based monitor enclosure.

FIG. 9, shows a detailed side view of the invention placed over a breast before a feeding cycle event begins.

FIG. 10, shows a detailed side view of the invention placed over a breast during a feeding cycle event.

FIG. 11, shows the passive capacitor plate bands electrically connected to a first hysteretic astable oscillator circuit means, whose output is in communication with a microcontroller; and the passive piezo-resistive thin film toroid electrically connected to a second hysteretic astable oscillator circuit means, whose output is in communication with a microcontroller.

FIG. 12, is a flow chart of the algorithm for the present invention.

### DETAILED DESCRIPTION OF EXEMPLARY EMBODIMENTS

The following detailed description is of the best currently contemplated modes of carrying out exemplary embodiments of the invention. The description is not to be taken in a limiting sense, but is made merely for the purpose of illustrating the general principles of said present invention, since the scope of said present invention is best defined by the appended claims.

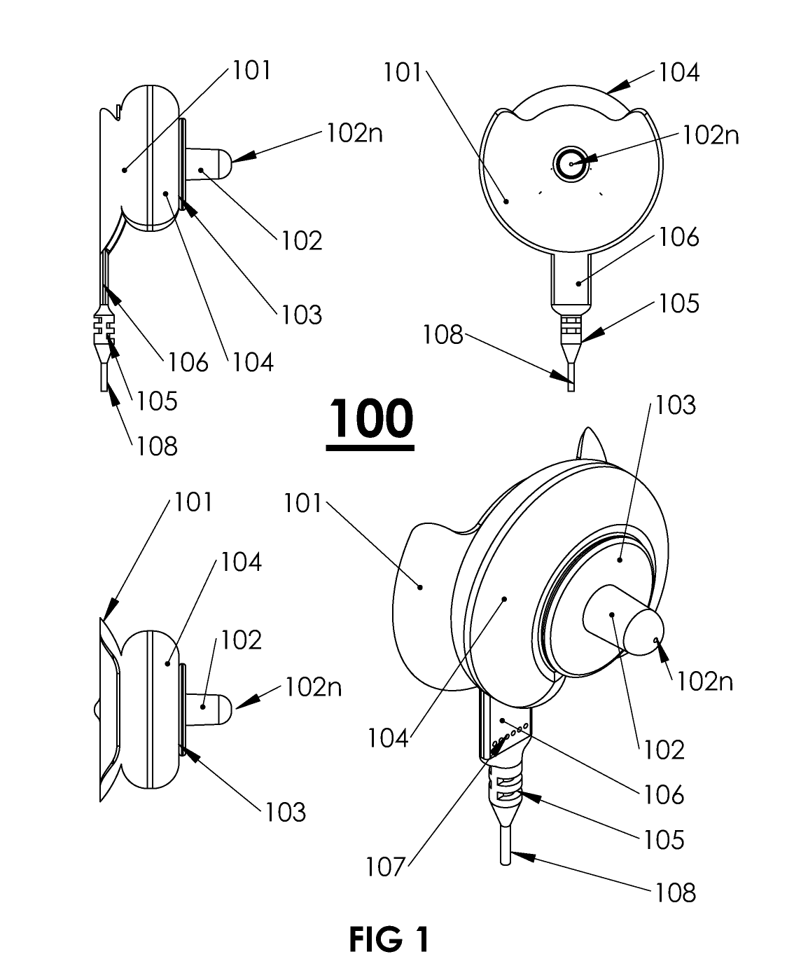

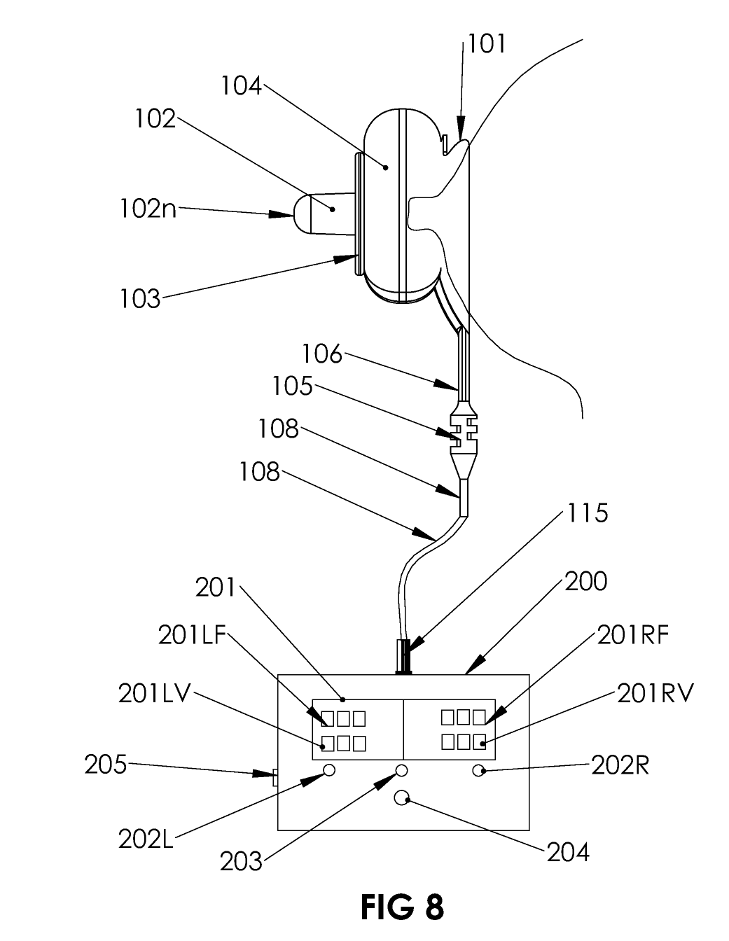

The present invention is a real time measuring device 100 according to one embodiment of the present invention is schematically shown in FIG. 1 and FIG. 8, when mounted on a mother's breast for a pediatric nourishment feeding session. According to this embodiment, the device comprises a cover cap 101 that is fashioned to effectively match a woman's breast and having a cannula and nipple region 102 with a nipple tip end with a small opening 102n for fluid exiting. Said cannula 102 is a hollow duct chamber region that upon continuous or sporadic ejection of nourishment fluid flow is the carrier for said nourishment fluid from a mother's breast to a pediatric recipient's mouth. Said flow path for a pediatric feeding session begins from the mother's breast that has said cover cap 101 mounted.

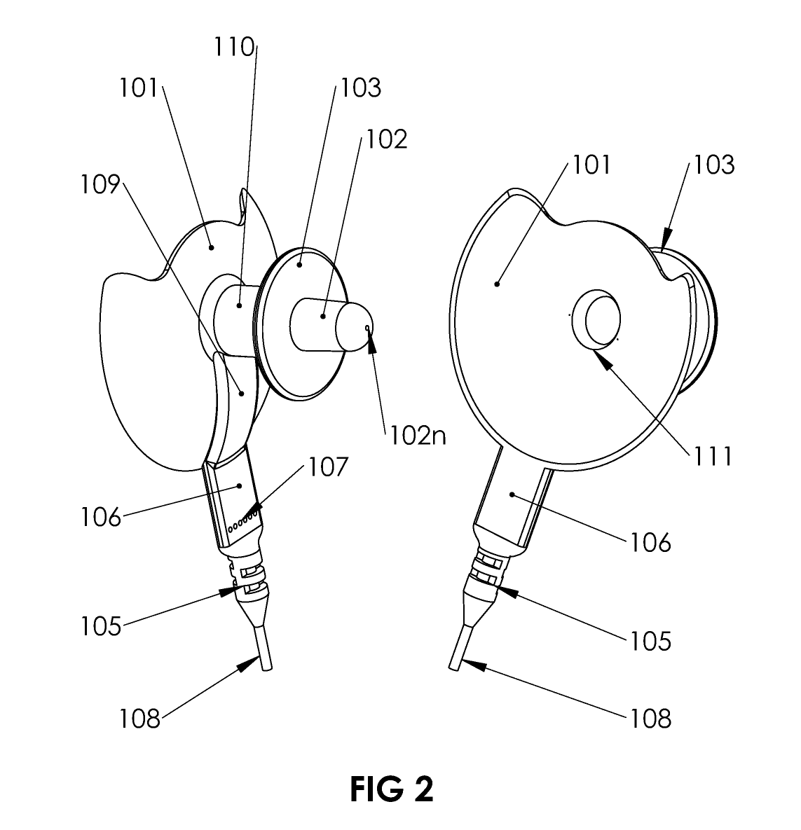

FIG. 2 shows that said cover cap 101 is in communication with embedded cylindrical electrical capacitor member means region 110 of the overall cannula, which is in communication with cannula member means region 102. Said cylindrical electrical capacitor member means 110 is embedded in between a silicone encapsulated contiguous stratum comprising the overall enclosure composition element according to one embodiment of the present invention. In FIG. 2 fluid entry from a mother's breast nipple enters the hole 111 of said cannula 110 and 102 and travels in a longitudinal flow through said cannula 102 on through to nipple exit hole 102n. FIG. 2 shows said piezo-resistive toroid member means 103 that is embedded in between a silicone encapsulated contiguous stratum comprising the overall enclosure composition element according to one embodiment of the present invention, and in communication with nipple region 102. Said toroid piezo-resistive member means 103 and said cylindrical electrical capacitor member means 110 are electrically connected and in communication with embedded system microcontroller circuit 106 by embedded etched circuit connection wires 109. Further, said embedded microcontroller circuit 106 is in communication with input/output port points 107. Said input/output ports 107 in FIG. 2 are utilized as a means of communication for data downloading and uploading. For sturdiness and long product lifetime, a strong and flexible cable support member means 105, capable of bending is utilized as a support means for the hard wired connections of cable 108 that connects to a monitor enclosure 200 that is shown in FIG. 8 that utilizes a connection plug 115.

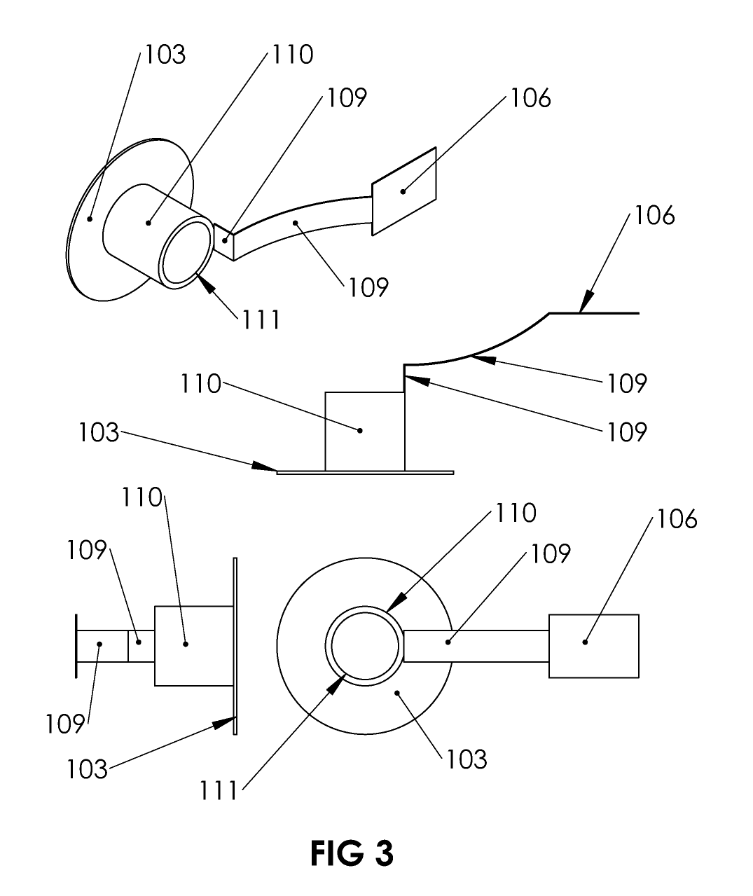

FIG. 3 shows said flexible etched printed circuit member means comprising; microcontroller circuit 106, connecting flat wire interconnect cable 109, cylindrical electrical capacitor member means region 110 that forms a hollow tubular conduit 111, and piezo-resistive toroid member means 103 is embedded in between a polyimide encapsulated contiguous stratum comprising the overall enclosure composition element according to one embodiment of the present invention. Whereupon said flexible etched circuit is embedded in between a silicone encapsulated contiguous stratum comprising the overall enclosure composition element according to one embodiment of the present invention.

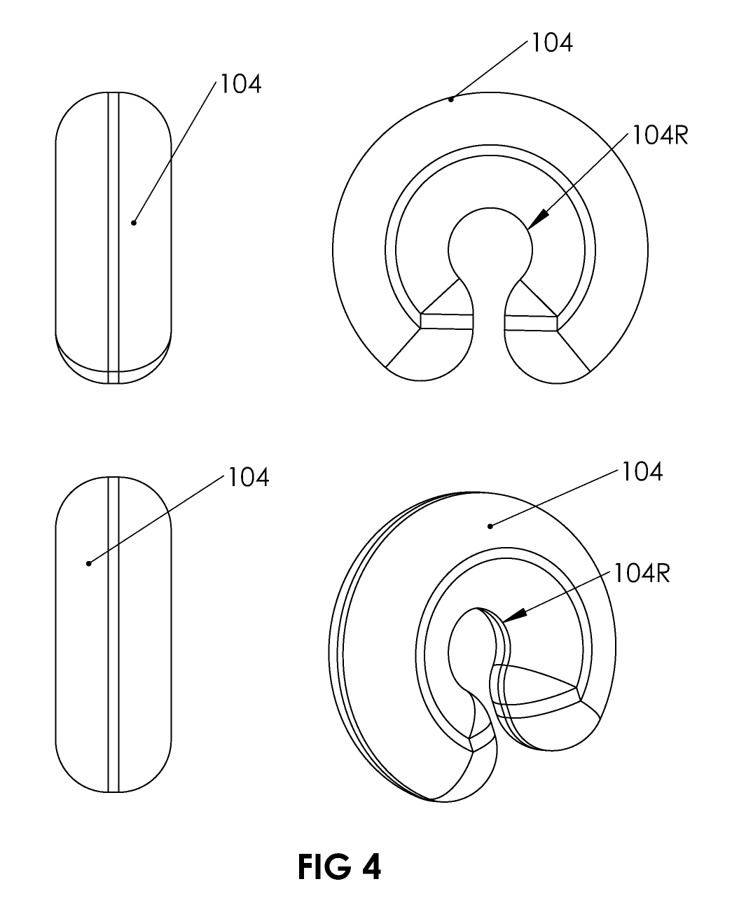

FIG. 4 shows a modified toroid air filled soft buffer comfort aid member means 104 with opening 104R that slips over the cannula region 110 and is positioned between and in communication with cover cap 101 and piezo-resistive toroid member means 103. Said modified toroid air filled soft buffer comfort aid member means 104 is a removable member means that is utilized for an infant's comfort and relaxation during a feeding session by allowing the infant to feel something soft as a mother's breast, since the actual mother's breast is out of communication with said infant.

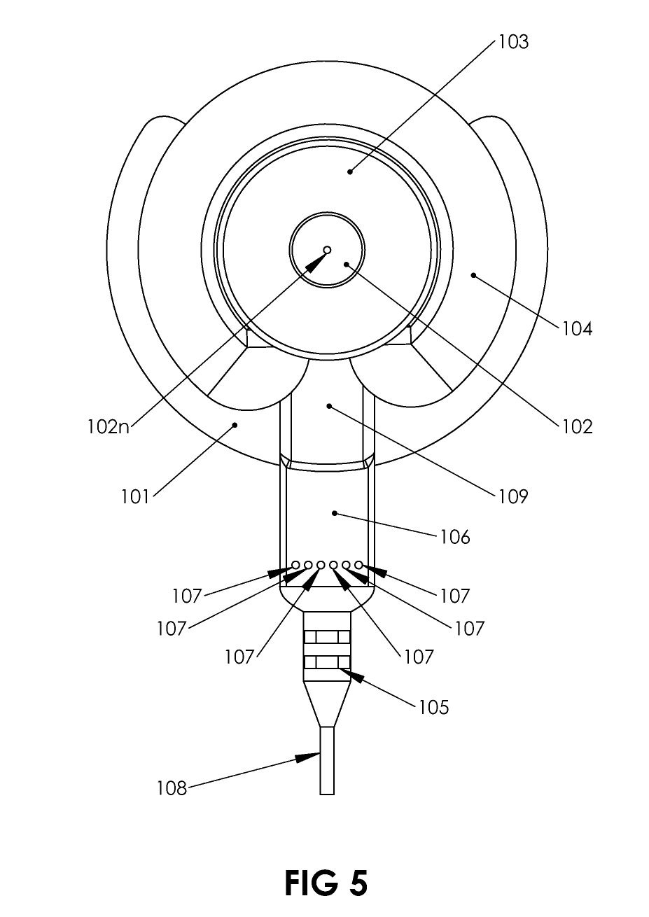

FIG. 5 shows showing a front view with six input/output ports 107 all, that are utilized for the uploading or downloading of data entry or collection for external feeding history.

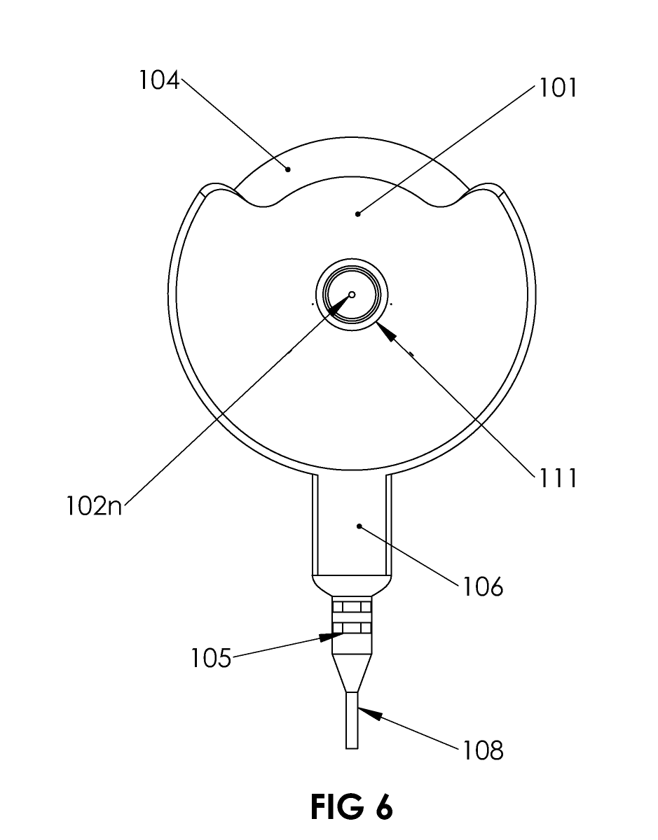

FIG. 6 shows the rear view as it would be applied onto a mother's breast.

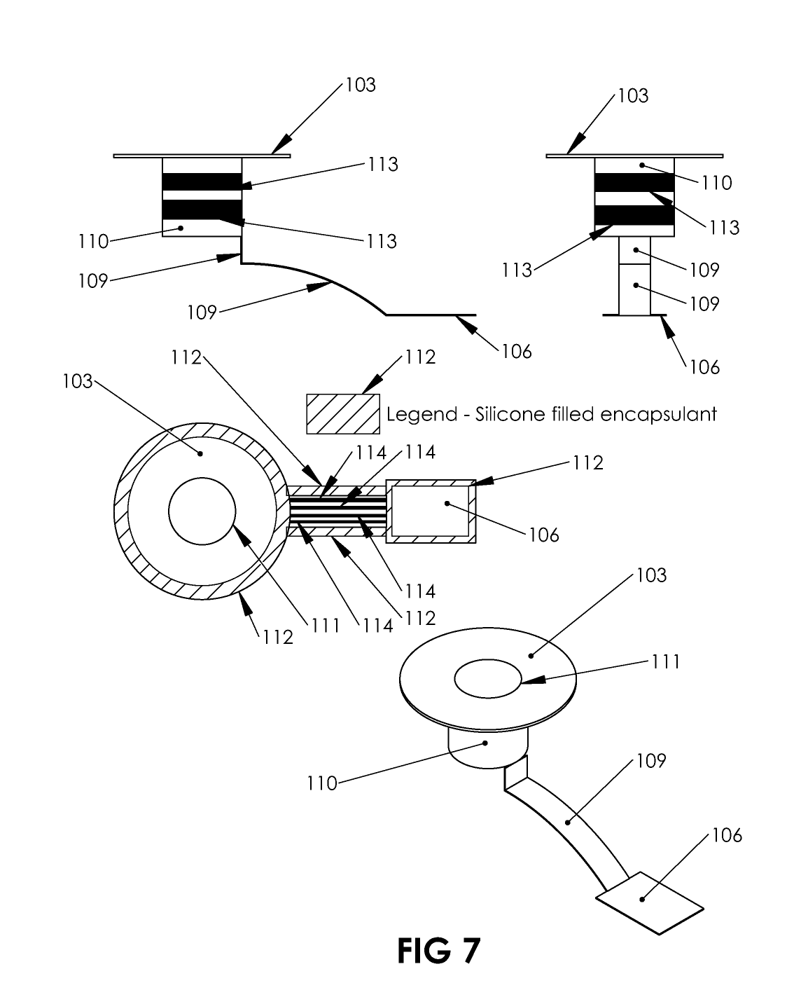

FIG. 7 shows comprehensive views of said flexible etched printed circuit member means comprising; microcontroller circuit 106, connecting flat wire interconnect cable 109, cylindrical electrical capacitor member means region 110 that forms a hollow tubular hole 111, and piezo-resistive toroid member means is embedded in between a polyimide encapsulated contiguous stratum comprising the overall enclosure composition element according to one embodiment of the present invention. Said cylindrical electrical capacitor member means region 110 that forms a hollow tubular hole 111 is comprised of two thin copper metal bands 113 that surround the circumference of said cylinder form, and said flexible etched printed circuit member means comprising; microcontroller circuit 106, connecting flat wire interconnect cable 109, cylindrical electrical capacitor member means region 110 that forms a hollow tubular conduit 111, and piezo-resistive toroid member means is encapsulated in a silicone encapsulate 112.

FIG. 8 shows the present invention 100 connected to its monitor enclosure 200. Said monitor enclosure 200 is comprised of a front alphanumeric display member means 201, an arrangement of a plurality of alphanumeric digital segment member means; for left breast flow monitor readout 201LF, a left breast volume monitor readout 201LV, a right breast flow monitor readout 201RF, and a right breast volume monitor readout 201RV. The left breast control button switch member means 202L toggles between left breast flow and volume, the right breast button switch member means 202R toggles between right breast flow and volume, and total accumulation button switch 203 is utilized for totaling a selected channel for any session feeding. The monitor 200 has an off/on button switch member means 204 on the front of said monitor enclosure.

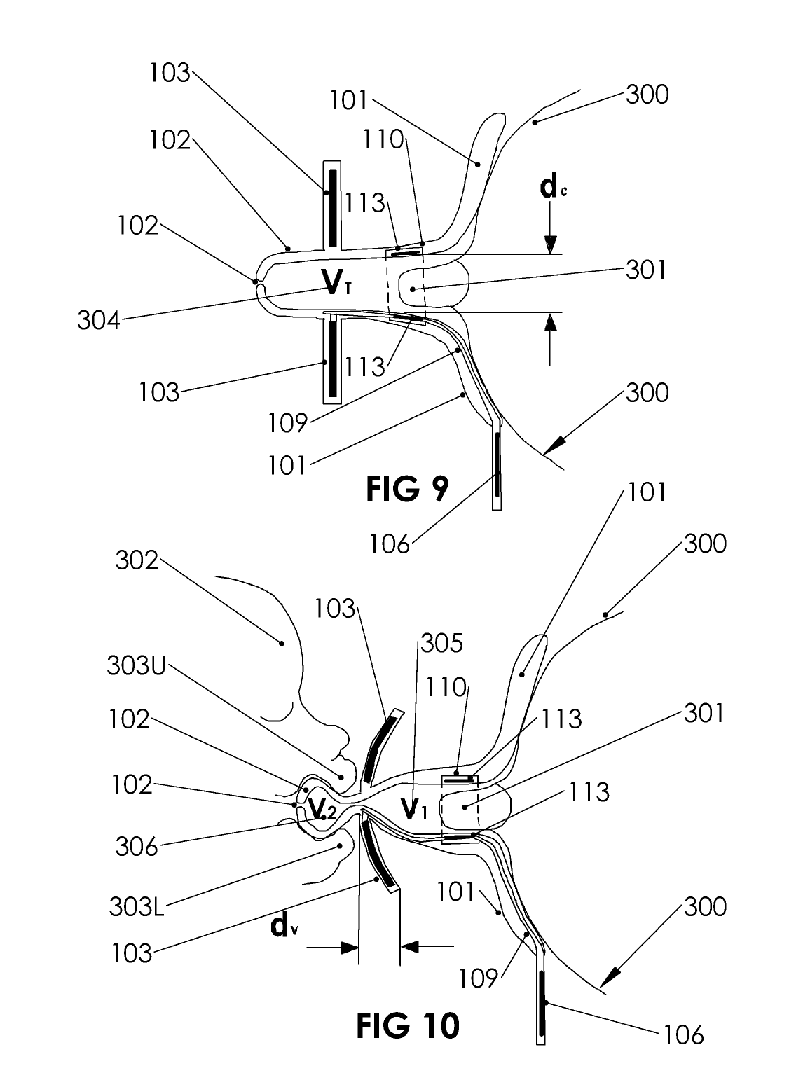

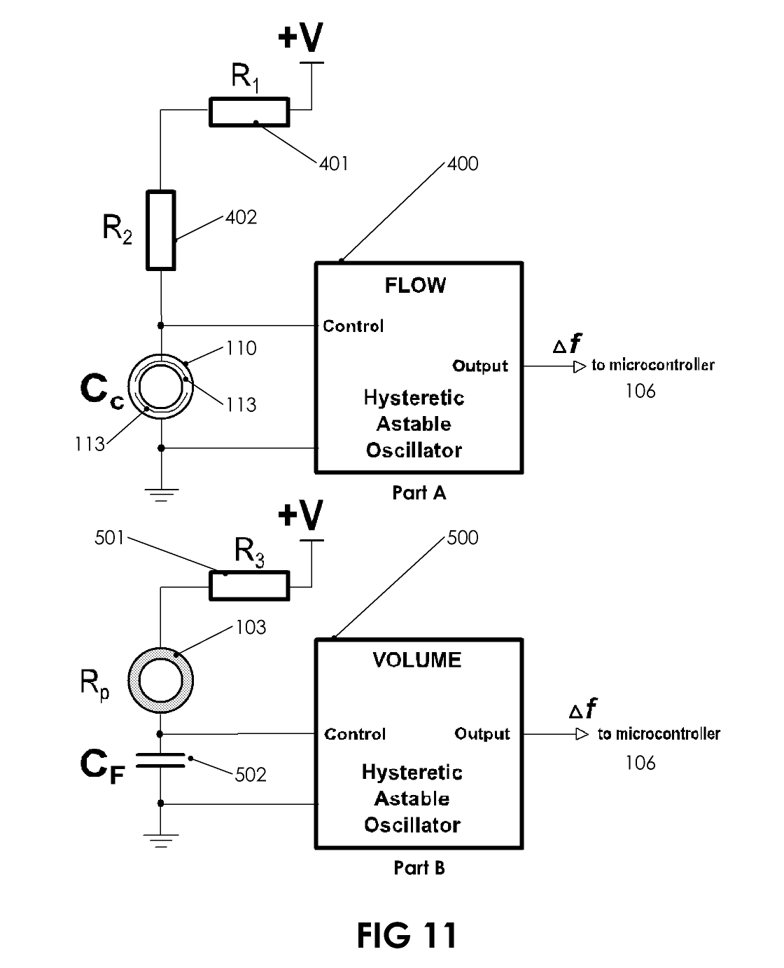

FIG. 9 is illustrative of an instance where said present invention 100 is placed over a mother's breast 300 and associated nipple 301. Utilizing said present invention 100 shown in FIG. 1 and FIG. 8, a feeding session begins with a calibration sequence, whereby a mother operated said monitor console 200 and presses either or both of said calibrate push button switches 202L for a left breast feeding and 202R for a right breast feeding. During this time of calibration said microcontroller member means 106 receives an initial frequency output from said hysteretic astable oscillator member means 400 as shown in FIG. 11. This initial reading is stored and represents a value of the dielectric constant between said plate bands 113 of passive cylindrical capacitor member means 110, before a mother's breast is inserted in cover cap 101. Ergo, the initial intrinsic dielectric constant is that of air. Meanwhile when a mother inserts one of her breasts, either left or right, into said cover cap member means 101 she presses said appropriate push button switch either left switch 202L or right switch 202R. As said breast enters, and is in place, said dielectric constant value of said cannula region member means 110, that houses said embedded passive cylindrical plate bands, increases because the dielectric constant of human tissue and milk is much greater than air. There are three dielectric constant conditions to consider associated with said passive cylindrical capacitor member means 110 and plate band member means 113; (1) when no breast or milk exists in said cannula region, (2) when a mother's breast is inserted in device and no lactation begins, so that there is only air plus a breast, and (3) when lactation begins and there is a mother's breast plus a volume 304 of milk fluid that exists in said cannula regions 110 and 102. These three different conditions result in three different dielectric constant values to be registered and used in flow and volume calculations by said microcontroller 106.

As illustrated in FIG. 10, when an infant begins sucking on nipple region 102 of said present invention 100, the mother starts lactating and her breast milk flows into said cannula region which is in part capacitor region 110 and nipple reservoir 102, where it exits at nipple orifice 102n and enters said infant's mouth as said infant clamps down on said nipple region 102 with its upper lip 303U and its lower lip 303L. All during said feeding session, where mother is lactating and milk is flowing, said capacitance value registers as a fluid presence condition in said microcontroller 106, and as said infant continues to feed as shown in FIG. 10 said infants lips 303U and 303L clamp down on a section of said cannula region 102, where therein exists a captured small volume 306 of milk fluid 305. Through precise and accurate programming algorithms, flow rate and volume of milk fluid consumed over time is calculated by said microcontroller 106.

For said passive cylindrical capacitor member means 110 comprised of plate band member means 113 that determines the presence of a breast and milk fluid volume, said capacitance value is mathematically determined by equation

(eq. 1);

$$C = \frac{k {ɛ}_{o} A}{( d + 2 π r )} \qquad eq . 1$$

Where; C=the capacitance of said capacitor 110 and associated plate bands 113,

A=area of said bands 113

k=relative permittivity of the dielectric material between the plates 113,

∈₀=8.854×10⁻¹² F/m,

(d+2πr)=distance between cylindrical plates 113.

FIG. 11 part A shows said passive cylindrical capacitor member means 110 and associated plate band member means 113 electrically in communication with hysteretic astable RC oscillator 400, where said passive cylindrical capacitance member means C_{c} 110 and a stable fixed resistors R₁ 401 and R₂ 402 remain in communication and are utilized to determine the resonant frequency of said hysteretic astable RC oscillator 400 by the equation (eq. 2) (this is for a typical 555 timer IC);

$${f}_{r} = \frac{1}{ln ( 2 ) \cdot {C}_{C} \cdot ( {R}_{1} + 2 {R}_{2} )} \qquad eq . 2$$

Substituting eq. 1 in eq. 2 for C_{c} gives a modified equation (eq. 3) for resonant frequency;

$${f}_{{r}_{1}} = \frac{1}{ln ( 2 ) \cdot \{ \frac{k {ɛ}_{O} A}{( d + 2 π r )} \} \cdot ( {R}_{1} + 2 {R}_{2} )} \qquad eq . 3$$

Where fᵣ_{₁} is the resonant frequency of flow oscillator 400 and the dielectric constant k relates to that volume of space occupied in said cannula region 110 within said capacitor plate bands 113, and changes against a calibrated value of air when a breast is inserted, and when a breast is inserted and lactation begins and milk fluid fills said cannula region 110 within said capacitor plate bands 113. It should be obvious to anyone steeped in the art that fᵣ_{₁} is inversely proportional to dielectric constant k, and that k is determined by conditions within said cannula region 110 that contains capacitor plate bands 113. Ergo, whenever said dielectric constant k changes due to changes from an air only condition to a breast entry only and further a breast entry plus milk fluid entry condition, the resonant frequency of said flow oscillator 400 will change, i.e. as the dielectric constant k increases when a breast and milk fluid enter said cannula region 110, the resonant frequency of flow oscillator 400 will decrease.

FIG. 11 part B shows said piezo-resistive member means Rₚ 103 that is in electrical communication with stable fixed resistor R₃ 501 and stable fixed capacitor C_{f} 502, and fixed resistor member means R₃ 501 and stable fixed capacitor member means C_{f} 502 remain in communication with hysteretic astable RC oscillator member means 500 and are utilized to determine the resonant frequency of said hysteretic astable RC oscillator 500 by the equation (eq. 4) (this is for a typical 555 timer IC);

$${f}_{{r}_{2}} = \frac{1}{ln ( 2 ) \cdot {C}_{C} \cdot ( {R}_{3} + 2 {R}_{p} )} , \qquad eq . 4$$

Where fᵣ_{₂} is the resonant frequency of volume oscillator 500 and Rₚ is the resistance value of toroid piezo-resistive member means 103. The design operating characteristics of said FlexiForce® piezo-resistive thin film embodiment or similar flexible piezo-resistive thin film embodiment 103 is such that whenever a deformation is created from the force of an infant 302 sucking on said nipple member means 102 by upper lip 303U and lower lip 303L, the value of resistance Rₚ of said FlexiForce® piezo-resistive thin film member means or similar flexible piezo-resistive thin film member means 103 decreases. Being that the resonant frequency fᵣ_{₂} of volume oscillator 500 is inversely proportional to the resistance Rₚ

As said infant 302 periodically sucks on nipple region 102, that contains said volume of milk fluid V₂ that is continuously pulled through volume V₁, said FlexiForce® piezo-resistive thin film member means or similar flexible piezo-resistive thin film member means 103 deforms as shown in FIG. 10 by a distance of dᵥ and said deformation bends toward the lactating mother. This to and fro action and deformation movement causes the resonant frequency of volume oscillator 500 to increase and decrease in frequency respectively, thus providing data to said microcontroller 106 for constant updating of volume consumed information that is made available for reading on said monitor console 200.

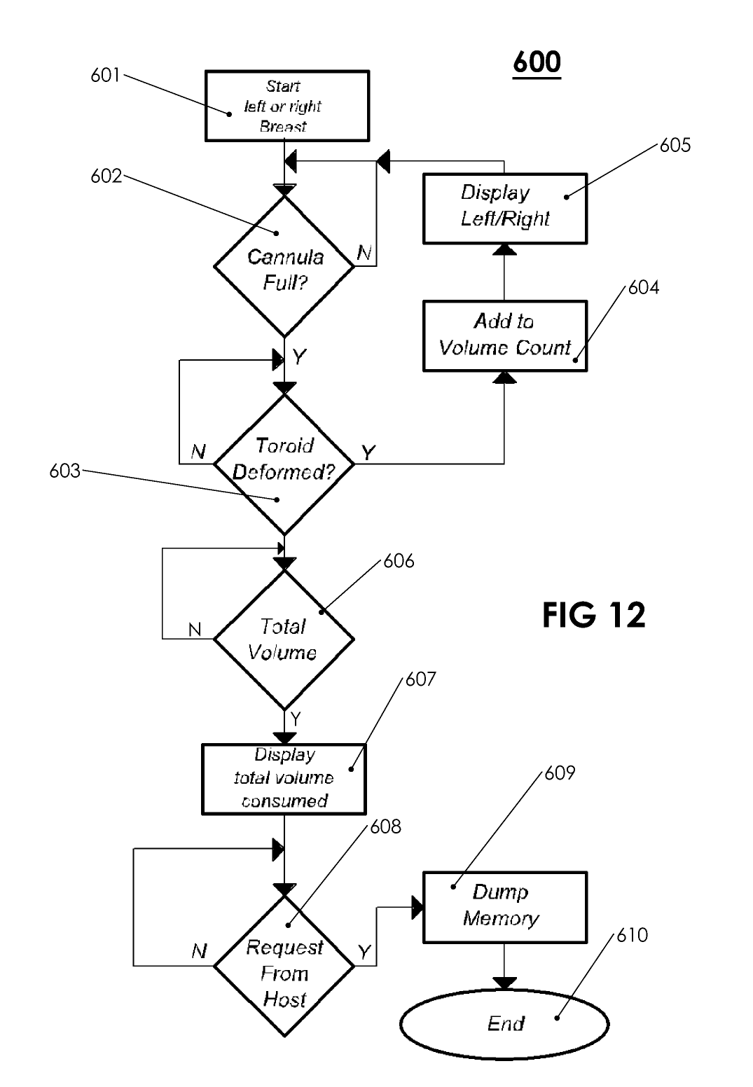

FIG. 12, shows a flow chart for one embodiment of the present invention's system operational algorithm set 600, which is the same for either said left breast data channel embodiment and said right breast data channel embodiment. Said algorithm flow begins at start either for said left or right channel 601, and said start point 601 is when this embodiment of the present invention 100 is fitted on a mother's breast and a host presses either said left breast channel operate button switch 202L or right breast channel operate button switch 202R. The next sequential logic decision making step 602 waits for said cannula 110 and 102 in FIG. 9 to filled with breast milk fluid volume V_{T}; this event takes place when said infant 302 in FIG. 10 commences to suck on said nipple region 102n of cannula section 102. Said event causes breast milk fluid to cause a shift in resonant frequency of flow oscillator 400 as shown in FIG. 11. A coefficient (d+2πr) distance d_{c} is used in eq. 3 and said center resonant frequency fᵣ of flow oscillator 400 deviates from center frequency downward to a lower frequency when a breast enters said cannula 110 region with plate bands 113 in FIG. 9 and FIG. 10; when said breast starts lactating said cannula 110 is filled with breast milk fluid and said center resonant frequency of said flow oscillator 400 of FIG. 11 deviates a second time further decreasing said frequency downward shift. This allows for said decision making step 602 to advance to the next logic decision making step to determine if said infant is sucking, thus causing said toroid embodiment 103 to deform and move in a direction towards said breast 300 as said infant 302 sucks and pulls on nipple region 102 to extract and consume continuously or sporadically, a small volume V₂ of breast milk fluid. If there is no deformation of toroid 103, the microcontroller waits for said presence of deformation signals generated by toroid 103. Upon receiving said signals form toroid, a flag signal enables a counter decision 604 to count consumption volume instantly consumed by said infant 302 and said value count is displayed, by display enable 605, on either said left flow display region 201LF, left display volume region 201LV or said right flow display region 201RF, right display volume region 201RV. Simultaneously, system program subset calculates a total feeding session history of volume consumed 606 and if a total count is not requested by host, said volume count continues; when host presses total volume button switch 203, that value accumulated is registered for storage and future use and displayed 607. After said total volume is displayed and stored, a decision subset 608 of said system program waits for a host request for either a continue sequence or stop program sequence, if no request for stop exists, said program and all of its sets and subsets remain operational; if a request to stop is requested by host, then a decision to dump memory 609 is executed and operation ends 610. Power to said system is administered and controlled by off/on button switch 205.

An embodiment is an implementation or example of said invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments of said present invention. The various appearances of “an embodiment,” “one embodiment,” or “some embodiments” are not necessarily all referring to the same embodiments.

If the specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Said present invention is not restricted to the particular details described herein. Indeed, many other variations of the foregoing description and drawings may be made within the scope of said present invention. Accordingly, it is the following claims including any amendments thereto that define the scope of said present invention.

What is claimed is:

1. A system and method means for the metrological determination of variations in a dielectric constant of a dielectric “Gaussian-volume” member means with its electric field potential intensity contained within the structure of a fixed measurement volume identified and situated between a plurality of metal plate bands that are electrically isolated from each other by said fixed measurement volume and its electrical signature of effect is capacitive reactive in nature; and said variations of dielectric constant from variations in a dielectric “Gaussian-volume” member means electric field potential and variations of dielectric constant influence are utilized by a computer algorithm as data values indicative of and for accurately determining the presence of a fluidic or solid object volume, or a combination of solid and flow of fluid entering from a fluid source, that further passes through a cannula or conduit member means that is longitudinal and parallel to a plurality of metal plate bands an onto a cannula or conduit region that is an exit orifice drain; and said variations in resistivity of said “Gaussian-volume” piezo-resistive material member means, whose volume is in a toroid form, and has its planar axis perpendicular to said longitudinal cannula or conduit member means; and a device and method means for the metrological determination of variations in a Gaussian volume of piezo-resistive material and its electrical signature is resistive in nature; and said variations in said “Gaussian-volume” piezo-resistive perpendicular toroid form member means influence are utilized by a computer algorithm as data values indicative of and for accurately determining the volume amount of continuous or sporadic fluid flow per unit time that is transferred and exited through an orifice drain into a collection accumulator; whereas an example of said fluid source can be a breast, but not limited to same; and whereas an example of said collection accumulator can be an infant's mouth, but not limited to same.

2. The system as recited in claim 1, wherein a first microcontroller, memory, firmware non-volatile memory, a plurality of hysteretic astable oscillators, that are mounted and in communication with each other on a thin polimide encapsulated flexible etched copper printed circuit arrangement, and are in communications with a dielectric “Gaussian-volume” member means and a perpendicular “Gaussian-volume” piezo-resistive material member means, and said thin polimide encapsulated flexible etched copper printed circuit arrangement with on board member means are encapsulated in medical grade silicone material means and are in physical communication with a cover cap and a longitudinal cannula or conduit nipple means with fluidic exit orifice means.

3. The system as recited in claim 1, wherein a dielectric “Gaussian-volume” member means is fabricated with thin copper plate bands that are flat and capable of bending and reforming into a cylinder shape, to form two or a plurality of electrically separate plate band shapes or a plurality of shape areas and fitted in between an encapsulated upper and lower region of medical grade silicone material means.

4. The system as recited in claim 1, wherein a perpendicular “Gaussian-volume” piezo-resistive material member means is formed into a thin film toroid shape or a plurality of shapes with a center opening that allows for flow through capabilities and all of said a perpendicular “Gaussian-volume” piezo-resistive material member means is formed into a thin film toroid shape minus the center opening, is fitted in between an encapsulated front and back region of medical grade silicone material means and said center opening remains open and free of encapsulate except for its inner ridge and outer rim area, which is encapsulated.

5. The system as recited in claim 1, wherein medical grade silicone is utilized to form and encapsulate said system total physical arrangement including cover cap, cannula or conduit, nipple and exit orifice region, and whose purpose is for FDA approval relating to hygienic integrity and assurance.

6. The system as recited in claim 2, wherein further comprising a stand-alone system monitor console that is portable, and powered by a rechargeable battery; containing a second microcontroller device means that is in communication with said dielectric “Gaussian-volume” member means and said “Gaussian-volume” piezo-resistive material member means, for receiving data and through said firmware computer algorithms, providing one or a plurality of real-time and stored alphanumeric visual information pertaining to fluid or solid or fluid and solid presence, flow rate, and volume exited through said orifice.

7. The system as recited in claim 6, wherein said monitor console has capabilities of monitoring all data, data updates and providing data collection and calculation method means for history analysis of said data; further capable of transferring said data and history to an external computer means; and having the feature of a wireless system to be in wireless communication with one or a plurality of wireless remote computer system means.

8. The system as recited in claim 6, wherein said monitor console has user friendly controls to display all data received from said dielectric “Gaussian-volume” member means and said “Gaussian-volume” piezo-resistive material member means, and to totalize any and all data from these member means for instant analysis and display for said user.

9. The system as recited in claim 2, wherein a plurality of input/output ports are provided for data upload or download utilized for the purpose of entering programming changes in system firmware or extracting data for external storage and analysis.

10. The system as recited in claim 1, wherein an soft air filled torus or an air permeated sponge type filler that is covered in a medical grade polymer material, with an opening that allows said torus to slide over said cannula section disposed between cover cap member means and said “Gaussian-volume” piezo-resistive material member means and remain situated in said position secured no until removed; whose function is to act as a comfort buffer zone for said infant feeding; said soft air filled or air permeated sponge type material benefits said infant from minimal contact interaction with said “Gaussian-volume” piezo-resistive material member means and benefits a lactating mother from infant interaction or interference, as well as providing stable support for said system that is comprised of a soft silicone material means.

11. The system as recited in claim 9, wherein a programmed algorithm whose instruction set is provided and is capable of being changed by a host in order to improve, update, modify, or replace system firmware by upload or download of data conveniently situated and disposed at a plurality of orifice entry points that are in communication with internal data bus lines of said system microcontroller.

12. The system as recited in claim 1, wherein all of the attributes of said present invention in another embodiment can be disposed and used for wireless, but not limited to wireless, metrological applications for determining flow and volume of fluids within a pipe system; where said fluid can be water.

13. The system as recited in claim 1, wherein all of the attributes of said present invention in another embodiment can be disposed and used for wireless, but not limited to wireless, metrological applications for determining flow and volume of fluids within a pipe system; where said fluid can be oil.

14. The system as recited in claim 1, wherein all of the attributes of said present invention in another embodiment can be disposed and used for wireless, but not limited to wireless, metrological applications for determining flow and volume of fluids within a pipe system; where said fluid can be a gaseous flow.

15. The system as recited in claim 1, wherein all of the attributes of said present invention in another embodiment can be disposed and used for wireless, but not limited to wireless, metrological applications for determining flow and volume of fluids within a pipe system; where said fluid can be a edible food fluid flow.

16. The system as recited in claim 1, wherein all of the attributes of said present invention in another embodiment can be disposed and used for wireless, but not limited to wireless, metrological applications for determining flow and volume of fluids within a pipe system; where said fluid can be a medical fluid flow as an aid in medical operations and diagnostic procedures.
